(19) United States
(12) Patent Application Publication
(10) Pub. No.: US 2007/0146790 A1
(43) Pub. Date: Jun. 28, 2007

(54) Method and apparatus for managing image files stored in external storage medium connected to image forming device

(75) Inventor: Min-su Park, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/604,851

(22) Filed: Nov. 28, 2006

(30) Foreign Application Priority Data
Dec. 28, 2005 (KR) 10-2005-0131903

(51) Int. Cl. G06K 15/00

(52) U.S. Cl. 358/1.16; 358/448

(57) ABSTRACT

A method and apparatus is provided for copying image files stored in an external storage medium into a built-in storage medium of an image forming device and managing the copied image files. The method includes sensing whether the external storage medium is connected to the image forming device and if it is sensed that the external storage medium is connected to the image forming device, storing the image files stored in the external storage medium in a storage unit included in the image forming device. Accordingly, when a user connects a portable storage medium to an image forming device, the user can easily manage the image files stored in the external storage medium using a user interface for copying the image files stored in the portable storage medium into a built-in storage medium of the image forming device when connection of the portable storage medium is sensed.

### CROSS-REFERENCE TO RELATED PATENT APPLICATION

This application claims the benefit under 35 U.S.C. §119(a) of Korean Patent Application No. 10-2005-0131903, filed in the Korean Intellectual Property Office on Dec. 28, 2005, the entire disclosure of which is incorporated herein by reference.

### FIELD OF THE INVENTION

The present invention relates to a method and apparatus for managing image files stored in a storage medium. More particularly, the present invention relates to a method and apparatus for copying image files stored in a portable storage medium connected to an image forming device into a built-in storage medium of the image forming device and managing the copied files.

### DESCRIPTION OF THE RELATED ART

Image forming devices in general have a function of converting a document edited by a user using an application program into encoded data and printing the encoded data onto paper.

Recently, image forming devices have been developed to be connectable directly to memory cards or universal serial bus (USB) flash drives that can store image files and print image files input from these external storage media, and/or include a high-capacity hard disk drive (HDD).

Portable storage media, such as memory cards and USB flash drives, have a relatively small storage capacity compared to the high-capacity HDD and may be easily lost and thus, are not appropriate for storing important image files for long periods of time.

Accordingly, a need exists for an improved system and method for copying and managing files from portable storage media.

### SUMMARY OF THE INVENTION

The present invention is provided to substantially solve the above and other problems and provides a method and apparatus for managing image files stored in an external storage medium connected to an image forming device, by which the stored image files can be easily copied into a built-in storage medium of the image forming device by connecting the portable storage medium to the image forming device.

According to an aspect of embodiments of the present invention, a method of managing image files stored in an external storage medium connected to an image forming device is provided, the method comprising sensing whether the external storage medium is connected to the image forming device and if it is sensed that the external storage medium is connected to the image forming device, storing the image files stored in the external storage medium in a storage unit included in the image forming device.

The method can further comprise determining whether the image files stored in the external storage medium are stored in the storage unit, or allowing a user to set storage options for storing the image files stored in the external storage medium in the storage unit.

The storage options can comprise at least one of an option for the automatic copy of all files, an option for the copy of all files, and an option for the selected copy of files.

The method can further comprise generating the name of a folder in which the image files are to be stored using at least one of the type of the external storage medium and the copy date and time if the user sets the automatic copy of all files option, wherein all image files stored in the external storage medium are stored in the folder having the generated name.

The method can further comprise allowing the user to select a folder in which the image files are to be stored from among folders of the storage unit if the user sets the copy all files option, wherein all image files stored in the external storage medium are stored in the selected folder of the storage unit.

The method can further comprise displaying information on folders existing in the storage unit.

The method can further comprise, if the user sets the copy selected files option, displaying information on the image files stored in the external storage medium. The user can select an image file to be copied to the storage unit from among the displayed image files of the external storage medium, and the user can select a folder in which the selected image file is to be stored from among folders of the storage unit, wherein the selected image file is stored in the selected folder of the storage unit.

The displayed image file information can comprise thumbnail images corresponding to the image files.

The method can further comprise displaying information on image files stored in the storage unit.

The display of the image file information can comprise sensing whether the power of the image forming device is turned on and if it is sensed that power of the image forming device is turned on, searching for folders of the storage unit generated by the automatic copy all files option and displaying information on the found folders. The user can then select one of the displayed folders and information on image files stored in the selected folder can be displayed.

The method can further comprise allowing the user to select at least one of the displayed image files and input a job for the selected image file, and then perform the input job for the selected image file.

According to another aspect of embodiments of the present invention, an apparatus for managing image files stored in an external storage medium connected to an image forming device is provided, the apparatus comprising a storage unit included in the image forming device and storing image files, an interface unit for sensing whether the external storage medium is connected to the image forming device and transmitting and receiving data to and from the external storage medium, and a controller for storing the image files stored in the external storage medium in the storage unit if it is sensed that the external storage medium is connected to the image forming device.

The apparatus can further comprise a user interface unit for displaying a message to inquire whether the user wishes to store the image files stored in the external storage medium in the storage unit and allow a user to determine whether to store the image files stored in the external storage medium in the storage unit.

The user interface unit can be configured to allow the user to set one of an option for the automatic copy of all files, an option for the copy of all files, and an option for the selected copy of files as a storage option.

When the automatic copy of all files option is set, the controller can generate the name of a folder in which the image files are to be stored using at least one of the type of the external storage medium and the copy date and time, and store all image files stored in the external storage medium in the folder having the generated name.

When the copy all files option is set, the user interface unit can allow the user to select a folder in which the image files are to be stored from among folders of the storage unit, and the controller can store all image files stored in the external storage medium in the selected folder of the storage unit.

When the copy selected files option is set, the user interface unit can display information on the image files stored in the external storage medium and allow the user to select an image file to be copied to the storage unit from among the displayed image files of the external storage medium and a folder in which the selected image file is to be stored from among folders of the storage unit, and the controller can store the selected image file in the selected folder of the storage unit.

The apparatus can further comprise a user interface unit for displaying information on image files stored in the storage unit.

According to another aspect of embodiments of the present invention, a computer readable recording medium storing a computer readable program for executing the image file managing method is provided.

### BRIEF DESCRIPTION OF THE DRAWINGS

The above and other features and advantages of embodiments of the present invention will become more apparent by describing in detail exemplary embodiments thereof with reference to the attached drawings, in which:

FIG. 1 is a block diagram of an exemplary apparatus for managing image files stored in an external storage medium according to an embodiment of the present invention;

FIG. 2 is a block diagram of an exemplary image forming device comprising an image file managing apparatus according to an embodiment of the present invention;

FIG. 3 illustrates an exemplary user interface provided to a user when an external storage medium is connected to an image forming device according to an embodiment of the present invention;

FIG. 4 is a flowchart illustrating an exemplary method of managing image files stored in an external storage medium according to an embodiment of the present invention;

FIG. 5 is a flowchart illustrating an exemplary method of managing image files stored in an external storage medium according to another embodiment of the present invention; and

FIG. 6 is a flowchart illustrating an exemplary method of managing image files copied into a built-in storage medium of an image forming device using an automatic copy of all files option according to an embodiment of the present invention.

Throughout the drawings, like reference numerals will be understood to refer to like parts, components and structures.

### DETAILED DESCRIPTION OF EXEMPLARY EMBODIMENTS

The present invention will now be described more fully with reference to the accompanying drawings, in which exemplary embodiments of the invention are shown.

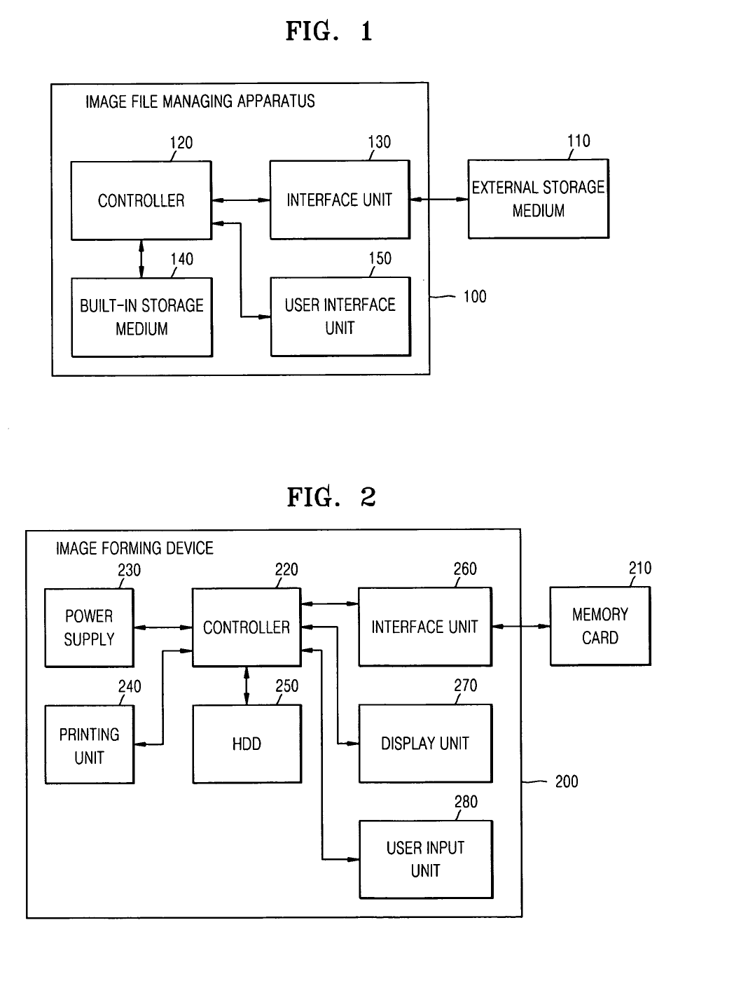

FIG. 1 is a block diagram of an exemplary apparatus 100 for managing image files stored in an external storage medium 110 according to an embodiment of the present invention. The image file managing apparatus 100 illustrated in FIG. 1 comprises a controller 120, an interface unit 130, a built-in storage medium 140, and a user interface unit 150. An exemplary operation of the image file managing apparatus 100 illustrated in FIG. 1 will now be described in conjunction with FIG. 4, which is a flowchart illustrating a method of managing image files stored in the external storage medium 110 according to an embodiment of the present invention.

The controller 120 controls the general operation of the interface unit 130, the built-in storage medium 140, and the user interface unit 150.

When the external storage medium 110 is connected to an image forming device, the interface unit 130 senses the connection of the external storage medium 110 in operation 400. The interface unit 130 communicates data with the connected external storage medium 110. The connection between the interface unit 130 and the external storage medium 110 can be a wired or wireless connection. Here, data may be transmitted or received using Bluetooth or wireless USB (WUSB) in the case of the wireless connection, and using USB in the case of the wired connection, but is not limited thereto.

Examples of the external storage medium 110 which can be connected to the image forming device comprise a compact flash (CF) memory card, a smart media (SM) memory card, an extreme digital (XD) memory card, a memory stick (MS), a secure digital (SD) memory card, a multimedia card (MMC) and so forth.

In operation 410, the user interface unit 150 displays a message to inquire whether the user wishes to copy all images stored in the connected external storage medium 110 into the built-in storage medium 140, e.g. a message such as “Do you want to copy all images from the connected external storage medium?”.

If a user selects an option to copy all image files in operation 420, the interface unit 130 receives all stored image files from the external storage medium 110, and the controller 120 stores the received image files in the built-in storage medium 140 in operation 430.

An exemplary method of managing image files stored in an external storage medium according to an embodiment of the present invention will now be described in greater detail.

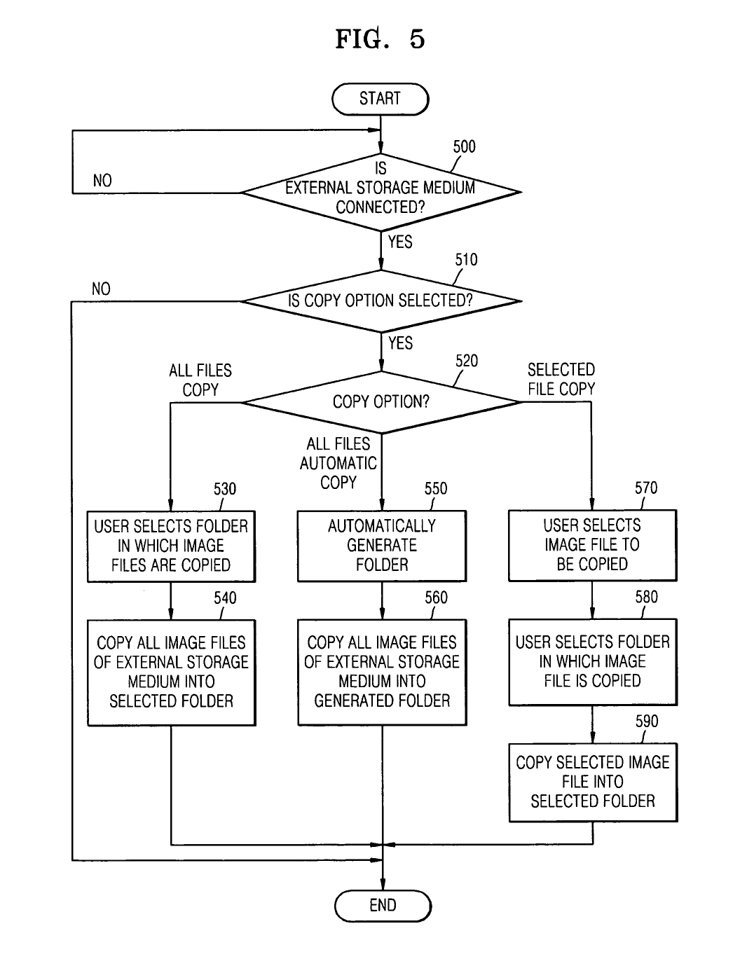

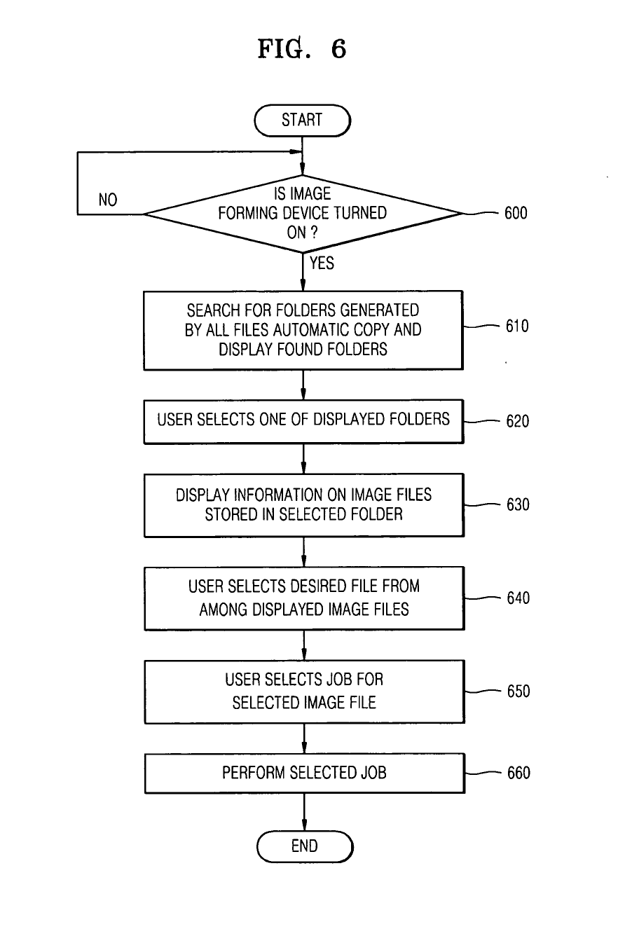

FIG. 2 is a block diagram of an exemplary image forming device 200 comprising an image file managing apparatus according to an embodiment of the present invention. The image forming device 200 illustrated in FIG. 2 comprises a controller 220, a power supply 230, a printing unit 240, a hard disk drive (HDD) 250, an interface unit 260, a display unit 270, and a user input unit 280. The operation of the image forming device 200 illustrated in FIG. 2 will now be described in conjunction with FIG. 5, which is a flowchart illustrating a method of managing image files stored in an external storage medium according to another embodiment of the present invention.

The controller 220 controls the general operation of the power supply 230, the printing unit 240, the HDD 250, the interface unit 260, the display unit 270, and the user input unit 280.

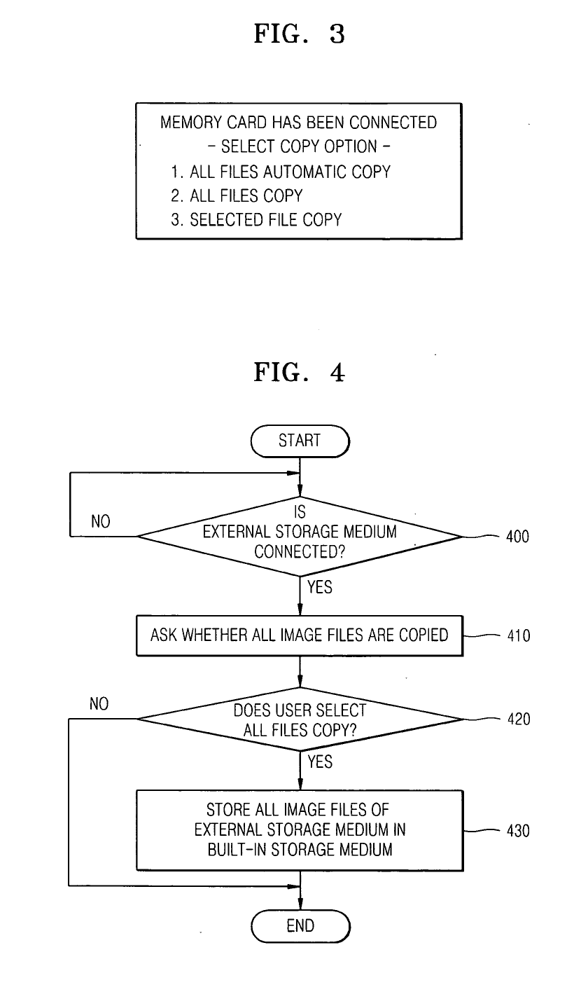

In operation 500, the interface unit 260 determines whether a memory card 210 is connected to the image forming device 200. If the memory card 210 is connected to the image forming device 200, the display unit 270 displays a message to inquire whether the user wishes to copy image files stored in the memory card 210 into the HDD 250 and displays information on selectable copy options. FIG. 3 illustrates an exemplary user interface provided to a user when the memory card 210 is connected to the image forming device 200 according to an embodiment of the present invention. As illustrated in FIG. 3, if the memory card 210 is connected to the image forming device 200, the user interface is provided through the display unit 270 providing information on the connection of the memory card 210 (e.g. “memory card has been connected”), allowing the user to select one of an automatic copy of all files option, a copy all files option, and a copy selected files option (e.g. “select copy option) and then copy image files stored in the memory card 210 into the HDD 250.

The user selects whether to copy the image files stored in the memory card 210 into the HDD 250, and selects one of the copy options. In operation 510, the controller 220 determines whether the user has selected a copy option for copying image files. If a copy option is selected, the controller 220 determines which copy option is selected and controls the interface unit 260, the display unit 270, and the user input unit 280 according to the selected copy option in operation 520.

If the copy all files option is selected by the user in operation 520, the display unit 270 receives information on folders in the HDD 250 from the controller 220 and displays the received folder information, and the user can select a folder or folders of the HDD 250 in which all image files stored in the memory card 210 are to be stored using the user input unit 280 in operation 530. In operation 540, the interface unit 260 transmits a signal for requesting transmission of all stored image files to the memory card 210 and receives all stored image files from the memory card 210, and the controller 220 stores the received all image files of the memory card 210 in the selected folder or folders of the HDD 250.

If the automatic copy of all files option is selected by the user in operation 520, the controller 220 generates a folder or folders of the HDD 250 in which all image files stored in the memory card 210 are to be stored in operation 550. The controller 220 can generate the name of the folder by combining type information of the memory card 210 and the copy date and time. For example, if the memory card 210 is a CF memory card and the copy date and time are 27 Sep., 2005, 10:30, the controller 220 can generate a folder named “CF_{—}2005/09/27/10:30” in which to store the image files. The type information of the memory card 210 can be received by the interface unit 260 from the memory card 210.

In operation 560, the interface unit 260 transmits a signal for requesting transmission of all stored image files to the memory card 210, and receives all stored image files from the memory card 210, and the controller 220 stores all the image files of the memory card 210 in the generated folder or folders of the HDD 250.

If the copy selected file option is selected by the user, the interface unit 260 transmits a signal for requesting information on stored image files to the memory card 210 and receives the information on image files stored in the memory card 210, and the display unit 270 displays the received image file information. The displayed image file information can comprise thumbnail images corresponding to the image files, but is not limited thereto. In operation 570, the user selects an image file to be copied to the HDD 250 from among the displayed image files using the user input unit 280.

In operation 580, the display unit 270 receives information on folders existing in the HDD 250 from the controller 220 and displays the received folder information, and the user can select a folder or folders of the HDD 250 in which the selected image file is to be stored using the user input unit 280. In operation 590, the interface unit 260 transmits a signal for requesting transmission of the selected image file to the memory card 210 and receives the selected image file from the memory card 210, and the controller 220 stores the received image file in the generated folder or folders of the HDD 250.

The user can use the user input unit 280 to request the selected image file to be printed, in which case the controller 220 outputs the selected image file to the printing unit 240 and controls the printing unit 240 to print the selected image file.

FIG. 6 is a flowchart illustrating an exemplary method of managing image files copied into the HDD 250 of the image forming device 200 using the automatic copy of all files option according to an embodiment of the present invention.

Referring to FIG. 6, when the user turns on the image forming device 200 in operation 600, the power supply 230 supplies power to the image forming device 200. Then, in operation 610, the controller 220 searches for folders automatically generated by the automatic copy of all files option among folders in the HDD 250, and the display unit 270 displays information on the found folders. As described above, since the names of the folders automatically generated by the automatic copy of all files option have a specific pattern, for example, the file name syntax described above, the controller 220 can find the folders automatically generated by the automatic copy of all files option by searching for folders having folder names of that pattern. The display unit 270 may then display the names of the found folders.

In operation 620, the user can select a folder in which an image file to be managed is stored, from among the displayed folders, using the user input unit 280. In operation 630, the display unit 270 receives information on image files stored in the selected folder of the HDD 250 and displays the received image file information. In operation 640, the user can select one or more image files from among the displayed image files using the user input unit 280. In operation 650, the user can select a job for the selected image file, e.g. printing, deleting, moving, or editing. In operation 660, the printing unit 240 and/or the controller 220 performs the selected job for the selected image file.

The present invention can also be embodied as computer readable code on a computer readable recording medium. The computer readable recording medium comprises any data storage device that can store data which can be thereafter read by a computer system. Examples of the computer readable recording medium comprise read-only memory (ROM), random-access memory (RAM), CD-ROMs, magnetic tapes, floppy disks, optical data storage devices, and carrier waves (such as data transmission through the Internet).

As described above, a method and apparatus can be provided for managing image files stored in an external storage medium according to embodiments of the present invention, and provide a user interface for copying up to all image files stored in a portable storage medium into a built-in storage medium of an image forming device when connection of the portable storage medium is sensed, thereby allowing the user to easily manage the image files stored in the external storage medium. In addition, by using a pattern for filenames of images stored in the built-in storage medium of the image forming device, an image file printing job can be easily performed.

While the present invention has been particularly shown and described with reference to exemplary embodiments thereof, it will be understood by those of ordinary skill in the art that various changes in form and detail may be made therein without departing from the spirit and scope of the present invention as defined by the following claims and equivalents.

What is claimed is:

1. A method of managing image files stored in an external storage medium connected to an image forming device, the method comprising:
sensing whether an external storage medium is connected to an image forming device; and
if it is sensed that the external storage medium is connected to the image forming device, storing image files stored in the external storage medium in a storage unit included in the image forming device.

2. The method of claim 1, further comprising determining whether to store the image files stored in the external storage medium in the storage unit based upon a user input.

3. The method of claim 1, further comprising determining a set storage option for storing the image files stored in the external storage medium in the storage unit.

4. The method of claim 3, wherein the storage options comprise at least one of an automatic copy of all files option, a copy all files option, and a copy selected files option.

5. The method of claim 4, further comprising:
generating a name of a folder in which the image files are to be stored using at least one of a type of the external storage medium and a copy date and time if the user sets the automatic copy of all files option,
wherein all image files stored in the external storage medium are stored in the folder having the generated name.

6. The method of claim 4, further comprising:
determining a selected folder in which the image files are to be stored from among folders of the storage unit if the user sets the copy all files option,
wherein all image files stored in the external storage medium are stored in the selected folder of the storage unit.

7. The method of claim 6, further comprising displaying information about folders in the storage unit.

8. The method of claim 4, further comprising:
if the user sets the copy of selected files option, displaying information about the image files stored in the external storage medium;
selecting an image file to be copied to the storage unit from among the displayed image files of the external storage medium; and
selecting a folder in which the selected image file is to be stored from among folders of the storage unit,
wherein the selected image file is stored in the selected folder of the storage unit.

9. The method of claim 8, wherein the displayed image file information comprises thumbnail images corresponding to the image files.

10. The method of claim 1, further comprising displaying information about image files stored in the storage unit.

11. The method of claim 10, wherein the display of the image file information comprises:
sensing whether power of the image forming device is turned on;
if it is sensed that power of the image forming device is turned on, searching for folders of the storage unit generated by the automatic copy of all files option and displaying information about the found folders;
selecting one of the displayed folders; and
displaying information about image files stored in the selected folder.

12. The method of claim 10, further comprising:
selecting at least one of the displayed image files;
inputting a job for the selected image file; and
performing the input job for the selected image file.

13. An apparatus for managing image files stored in an external storage medium connected to an image forming device, the apparatus comprising:
a storage unit included in an image forming device for storing image files;
an interface unit for sensing whether an external storage medium is connected to the image forming device, and transmitting and receiving data to and from the external storage medium; and
a controller for storing the image files stored in the external storage medium in the storage unit if it is sensed that the external storage medium is connected to the image forming device.

14. The apparatus of claim 13, further comprising a user interface unit for displaying a message to elicit a user input command to store the image files stored in the external storage medium in the storage unit.

15. The apparatus of claim 14, wherein the user interface unit is configured to set one of an automatic copy of all files option, a copy all files option, and a copy selected files option as a storage option in response to a user input command.

16. The apparatus of claim 15, wherein when the automatic copy of all files option is set, the controller is configured to generate a name of a folder in which the image files are to be stored using at least one of a type of the external storage medium and a copy date and time, and store all image files stored in the external storage medium in the folder having the generated name.

17. The apparatus of claim 15, wherein when the copy all files option is set, the user interface unit is configured to select a folder in which the image files are to be stored from among folders of the storage unit in response to a user command, and
the controller is configured to store all image files stored in the external storage medium in the selected folder of the storage unit.

18. The apparatus of claim 15, wherein when the copy selected files option is set, the user interface unit is configured to display information about the image files stored in the external storage medium and select an image file to be copied to the storage unit from among the displayed image files of the external storage medium, and select a folder in which the selected image file is to be stored from among folders of the storage unit, in response to a user command, and
the controller is configured to store the selected image file in the selected folder of the storage unit.

19. The apparatus of claim 13, further comprising a user interface unit for displaying information about image files stored in the storage unit.

20. A computer readable recording medium storing a computer readable program for managing image files stored in an external storage medium connected to an image forming device, comprising:
a first set of instructions for sensing whether an external storage medium is connected to an image forming device and if it is sensed that the external storage medium is connected to the image forming device; and
a second set of instructions for storing image files stored in the external storage medium in a storage unit included in the image forming device.

21. A method of managing image files stored in an external storage medium connected to an image forming device, the method comprising:
accessing an external storage medium when connected to an image forming device; and
selectively storing files stored in the external storage medium in a storage unit of the image forming device.

22. The method of claim 21, further comprising connecting the external storage medium to the image forming device via a wired connection.

23. The method of claim 21, further comprising connecting the external storage medium to the image forming device via a wireless connection.

24. The method of claim 21, wherein the external storage medium comprises at least one of a compact flash (CF) memory card, a smart media (SM) memory card, an extreme digital (XD) memory card, a memory stick (MS), a secure digital (SD) memory card and a multimedia card (MMC).

25. The method of claim 21, further comprising:
displaying a message to inquire whether the user wishes to copy images stored in the connected external storage medium into the storage unit; and
selectively storing image files from the external storage medium in the storage unit in response to a user input.

26. The method of claim 21, further comprising storing image files from the external storage medium in the storage unit in folders identifiable by external storage medium type and date and time of storage in the storage unit.

27. An apparatus for managing image files stored in an external storage medium connected to an image forming device, the apparatus comprising:
an image forming device comprising a storage unit for storing data;
an interface unit for transmitting and receiving data to and from an external storage medium; and
a controller for selectively storing data from the external storage medium in the storage unit in response to a user command.

28. The apparatus of claim 27, wherein the interface unit is configured to connect the external storage medium to the image forming device via a wired connection.

29. The apparatus of claim 27, wherein the interface unit is configured to connect the external storage medium to the image forming device via a wireless connection.

30. The apparatus of claim 27, wherein the external storage medium comprises at least one of a compact flash (CF) memory card, a smart media (SM) memory card, an extreme digital (XD) memory card, a memory stick (MS), a secure digital (SD) memory card and a multimedia card (MMC).

31. The apparatus of claim 27, wherein the controller is configured to store image files from the external storage medium in the storage unit in folders identifiable by external storage medium type and date and time of storage in the storage unit.

32. The apparatus of claim 27, further comprising a user interface unit configured to receive user commands and display identifiable folder information.
